(19) United States
(12) Patent Application Publication
(10) Pub. No.: US 2023/0385739 A1
(43) Pub. Date: Nov. 30, 2023

(54) Strategic Decisions Method Comparing Risks, Performance Outcomes, and Scenarios

(71) Applicants: Alfonso Gonzalo Bastias Largo, Boulder, CO (US); David B. Ashley, Oakwood, OH (US); Luis Fernando Alarcón Cárdenas, Santiago (CL)

(72) Inventors: Alfonso Gonzalo Bastias Largo, Boulder, CO (US); David B. Ashley, Oakwood, OH (US); Luis Fernando Alarcón Cárdenas, Santiago (CL)

(21) Appl. No.: 17/752,446

(22) Filed: May 24, 2022

(51) Int. Cl. G06Q 10/06

(52) U.S. Cl. CPC G06Q 10/06375; G06Q 10/0635

(57) ABSTRACT

A novel strategy analysis methodology predicts multiple performance outcomes and related risks for different strategy choices. It uses a structured, hierarchical representation of the organization and business opportunities under consideration. The user can choose the number of hierarchy levels and the number of factors considered at each hierarchy level. Factors and links among factors have probabilistic representations. The invention combines historical data, expert judgment, and Monte-Carlo simulation in a computer implementation to identify preferred strategies. Sensitivity analyses and scenario variations test the robustness of preferred strategies. Example applications of the invention include new business venture choice, alternate production process selection, resource supply chain options, capital project delivery approach, and rare-event rapid response evaluation.

### CROSS-REFERENCE TO RELATED APPLICATIONS

This application claims the benefit of provisional patent application Ser. No. 63/202,070, filed 2021 May 26 by the present inventors.

### FIELD OF THE INVENTION

The field of the invention is management support systems for decision making. The invention relates to creating and evaluating management strategies for business ventures or capital expenditure decisions. More particularly, the present invention relates to decision-making logic using a computer-based platform, data, expert judgment, structure, and simulation analysis to support a strategic decision process.

### BACKGROUND

### Prior Art

The following is a tabulation of some prior art that presently appears relevant:

### U.S. Patents

| U.S. Pat. No. | Kind Code | Issue Date | Patentee |
|---|---|---|---|
| 6,115,691 | | Sep. 5, 2000 | Ulwick |
| 6,876,991 | B1 | Apr. 5, 2005 | Owen |
| 8,620,852 | B1 | Dec. 31, 2013 | Kipersztok |
| 10,537,801 | B2 | Jan. 21, 2020 | Naveh |

### U.S. Patent Application Publications

| Publication # | Kind Code | Publication Date | Applicant |
|---|---|---|---|
| 2003/0069869 | A1 | Apr. 10, 2003 | Gronau |
| 2003/0093310 | A1 | May 15, 2003 | Macrae |
| 2003/0130884 | A1 | Jul. 10, 2003 | Michaluk |
| 2003/0182337 | A1 | Sep. 25, 2003 | Wefers |
| 2004/0073442 | A1 | Apr. 15, 2004 | Heyns |
| 2017/0103353 | A1 | Apr. 13, 2017 | Sickles |
| 2018/0218299 | A1 | Aug. 2, 2018 | Chang |

### Nonpatent Literature Documents

Alarcón, L. F., and Ashley, D. B., “A Cross Impact Methodology for Project Decision Making”, International Journal of Project Management, Vol. 16, No. 3, pp. 145-152, 1998.
Venegas, P. and Alarcón, L. F., “Selecting Long Term Strategies for Construction Firms”, Journal of Construction Engineering and Management, ASCE, Vol. 123 No. 4, pp. 388-389, December 1997.
Alarcón, L. F., and Ashley, D. B., “Modeling Project Performance for Decision Making”, Journal of Construction Engineering and Management, ASCE, Vol. 122 No. 3, pp. 265-273, September 1996.

### Patent Classification Codes for Search

International CI.: A63F 13/46, G06N 5/00, G06F 17/60, G06F 7/38, G06F 15/18, G06N 5/02, G06Q 10/06, GO6Q 40/00,

U.S. CI.: 706/46, 706/52, 705/1, 705/7, 705/8, 705/10, 705/11, 706/46, 708/490

### Narrative

The present invention builds on and extends a long history of decision-theory concepts and tools. Bayes' Theorem from the 18th century and the seminal work by von Neumann and Morgenstern, Theory of Games and Economic Behavior (1944), provide essential foundations for subjective probability assessments and utility theory. Expansions to applied decision theory by Raiffa and Howard in the 1960s and 1970s created basic frameworks for modeling and analyzing decisions under uncertainty. In the 1970s, Keeney, Raiffa, Zionts, and others, further extended these decision problems into multi-attribute dimensions and emphasized decision-maker preferences. Influence diagrams, a generalization of Bayesian networks including both probability and decision nodes, were developed in the mid-1970s to represent and communicate more complex decision problems.

In the 1990s, the inventors combined all these elements and more into a General Performance Model (GPM) allowing a structured probabilistic representation of capital project decisions, primarily focused on construction project delivery strategies. The structure had two levels, drivers, and internal processes, and allowed predictions of several outcome measures; thus, initial uses were limited in scope, dimensions, and applicability. The present invention is a novel and meaningful expansion of this initial framework in terms of levels, numbers of factors, analysis capabilities, the inclusion of scenario alternatives, and uses.

### BRIEF SUMMARY OF THE INVENTION

A method with computer implementation for a novel strategy analysis methodology is provided. The invention predicts multiple outcomes performance and related risk values for different strategy-option combinations. The method uses a structured, hierarchical representation of the organization and ventures under consideration with each level of the hierarchy having a user-defined number of factors. Factors and links among factors have probabilistic representations. The invention uses historical data, domain expert judgment, and Monte-Carlo simulation for performance predictions. Sensitivity analyses and scenario variations test the robustness of preferred strategies. Uses of the invention include new business venture choice, alternate production process selection, resource supply chain options, capital project delivery approach, and rare-event rapid response evaluation. The method is referred to throughout this patent application as the Strategy Performance Engine (SPE).

### BRIEF DESCRIPTION OF THE DRAWINGS

The embodiments of the present invention will become better understood when the following detailed description is reviewed concerning the accompanying drawings. Some embodiments of the present invention are illustrated as an example and are not limited by the figures of the accompanying drawings, in which like references may indicate similar elements and in which:

FIG. 1 depicts the general framework of the method showing several of the key components and their relationships to one another.

FIG. 2 shows the central operating component, the SPE-Core, with its four sub-components.

FIG. 3 shows an expanded view of the generalized variable structure within the SPE-Core.

FIG. 4 shows how variable information is collected as subjective, expert input.

FIG. 5 shows how subjective information is collected for the performance outcome variables.

FIG. 6 depicts how the different probability assignments are made to the different regions of the cumulative probability distribution.

FIG. 7 shows the complete view of the relationships of the variables in a cross-impact matrix.

FIG. 8 shows a detailed view of a single set of patterns (example).

FIG. 9 provides an example of how a probability distribution is shifted into a posterior probability distribution by the impact probabilities.

FIG. 10 provides an analysis flowchart depicting how the simulation is executed in the computer implementation.

FIG. 11 shows how a strategy is defined as multiple layers with each layer focused on a subset of options.

FIG. 12 depicts how different strategies are defined as unique combinations of options within the strategy and how these options influence variables at any level of the method.

FIG. 13 shows how marginal probability distributions are combined via simulation analysis to generate an approximate joint probability distribution within the method.

FIG. 14 depicts the Scenario component within the method framework.

FIG. 15 shows how a Scenario is input and defined by a user.

FIG. 16 depicts how a Scenario is defined as a combination of external agents or ExoAgents with modifications of a base case.

FIG. 17 shows an example of how scenario input on the initial probabilities of ExoAgents modifies the base values of other variables.

FIG. 18 provides an example sensitivity analysis portraying how a performance outcome variable may be changed by varying the influence level of any core variable; and

FIG. 19 provides an example of how the expected value of multiple performance outcomes varies by choice of strategy.

### DETAILED DESCRIPTION OF THE INVENTION

### Problem Being Solved

An organization's strategic decisions are typically longer-term in nature and involve significant resource commitments; often, these decisions are irreversible. Usually, the analyses supporting this decision-making are ad hoc and the decision quality is correspondingly highly varied. The present invention provides a structured, decision-theoretic framework with a rigorous, computer-implemented analysis engine to compare a base strategy to a wide range of options. Subjective expert opinion and historical data are combined in a disciplined manner. Sensitivity and scenario alternatives analyses allow strategy options to be tested for reasonableness and robustness. Decisions can thus be based on comparisons of multiple performance outcomes prediction and their related risks.

### Structure and Data

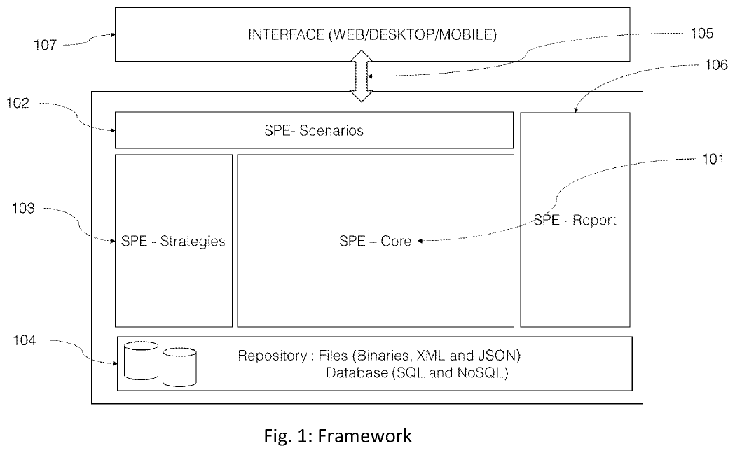

FIG. 1 depicts the overall structure for the method including interfaces with external data sources and users, a data repository with historical data and internal analysis results, definition modules for both strategy combinations and alternate scenarios, a report generator, and the core analysis module or Strategy Performance Engine (SPE). Data flows between modules and flows are typically in both directions. The computer implementation of the method utilizes this module structure. The core of the system (sub-figure 101 abbreviated as sf101) connects directly to four components: Scenario Generation (sf102), Strategies (sf103), Database (sf104), and Reports (sf106). Each component interacts with the SPE-core or simulation engine. All modules are connected to the user interface (sf107) through an Application Programming Interface API (sf105). This figure provides a full overview of the system. The next figures show detailed views of each component, with their subcomponents.

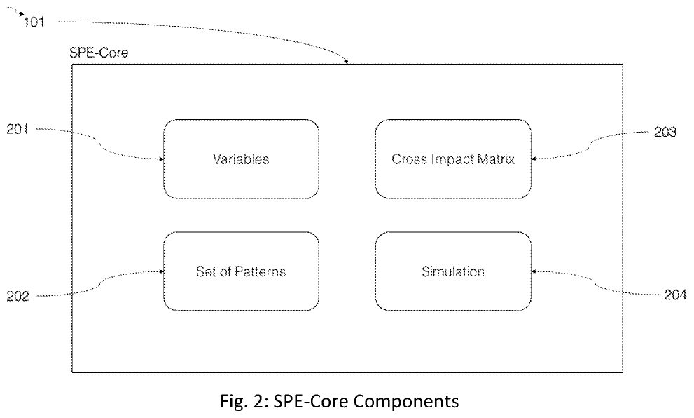

FIG. 2 takes the central module of the framework, the SPE-Core, and further breaks down its main subcomponents. This division includes three structures for the data: Variables (sf201), Set of Patterns (sf202), and Cross Impact Matrix (sf203). The other subcomponent uses the data provided to simulate (sf204) the impact of decisions or changes. The complete SPE-Core is a Monte-Carlo simulation analysis that combines random variables, structured relationships, probability settings, and computer-based simulation logic.

The random variables are state-of-information uncertainty estimates of the range of values attributable to the variable's possible values. A cross-impact matrix represents the probabilistic influences of variables on succeeding variables; these are conditional probability influences where an actual value of one variable influences the likely outcome for the succeeding variables. The cross-impact matrix provides a structure and aggregated means for representing these influences. The aggregation is achieved by organizing the influence level into discrete bands of probabilistic ranges.

The set of patterns is used as a means of assessing and communicating within the method the strength of influence from one variable to the next. The SPE-Core starts with a default set of patterns and allows users to adjust these patterns to represent the users' experiences more accurately.

The simulation component within the SPE-Core is the Monte-Carlo methodology of sampling individual variables within the core and then propagating this sampled value to the next variable. Each “run” of the Monte-Carlo simulation samples each variable once and generates single values for each of the outcome variables. Another run of the simulation generates another set of sampled variables and individual values for each outcome. The outcome variable results create probability distributions from all the simulation runs.

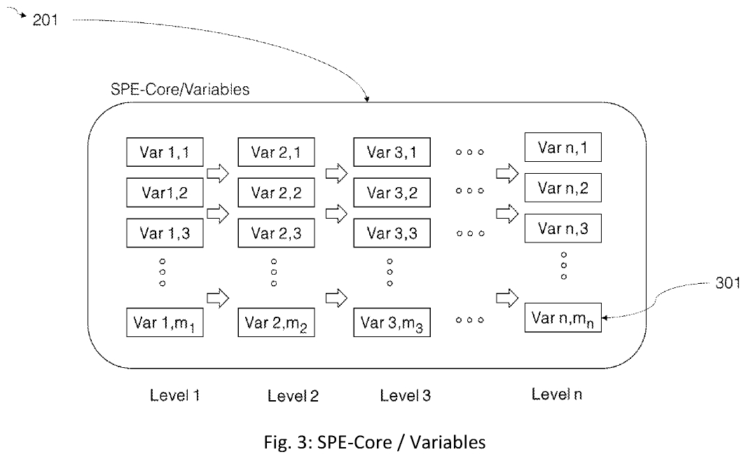

FIG. 3 depicts the details within the Variable subcomponent of the SPE-Core. The proposed method has an organized structure with n levels defined by the user. Each level may have a different number of variables. For example, variable Var_{3,5} is the 5^{th} variable on the 3^{rd} level. Levels allow the method to represent a sequential flow of causality from one variable to the next. For example, Level 2 could depict geographic divisions of the organization and Level 3 could represent functional units within each geographical unit. A succeeding Level could be elements of a particular project or market sector. Thus, the structuring approach taken by the proposed method flows directly from the business structure and operations of the organization. The generality of this structure allows any organization of any size or complexity to be reasonably represented.

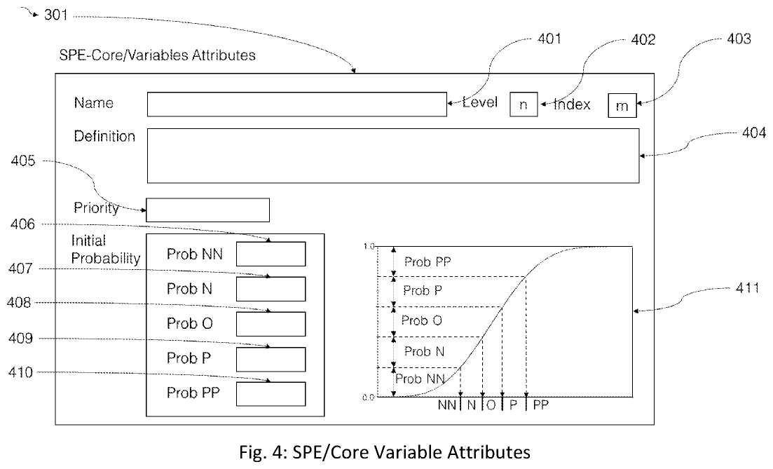

As shown in FIG. 4, each variable has a defined set of attributes collected or initially assessed by expert users: Name (sf401), Definition (sf402), Level (sf402) and index inside the appropriate level (sf403). The Priority defines the execution order in the simulation process (sf405). Each variable captures its behavior under five predefined scales (from NN which represents a negative behavior to PP which represents a positive behavior. Each value represents a probability of occurrence. For consistency, the sum of probabilities assigned to NN through PP must be 1.0, (i.e., the value of sf406+sf407+sf408+sf409+sf410=1.0). The cumulative distribution is shown in sf411.

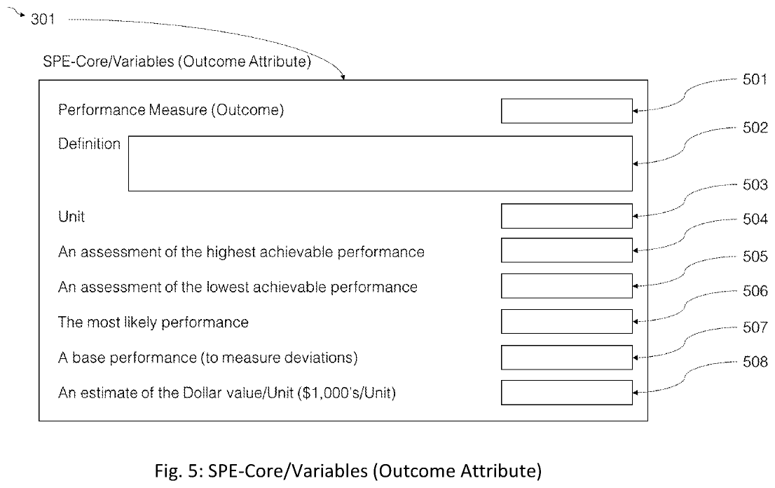

FIG. 5 represents the special case of the variables in the last Level or the Performance Outcome variables. For purposes of this method, the Performance Outcome variables are also defined as the Performance Measures. Each Performance Measure has an assessed a priori probability distribution that may be subjectively assessed as a three-point beta, or similar, probability density function. In this example, the three points used to create the beta distribution are the highest achievable, most likely, and lowest achievable performance. The method and assessment approach also allows the input of a base or desired performance level that may be used to compare simulation results to base or desired performance, for the highest (sf504), lowest (sf505), and most likely value (sf506) to adjust it to a beta distribution. Additional information is collected to incorporate in the reports like the unit of measure (sf503), base performance (sf507), and an estimate of the tradeoff of dollar-value/unit of measure (sf508).

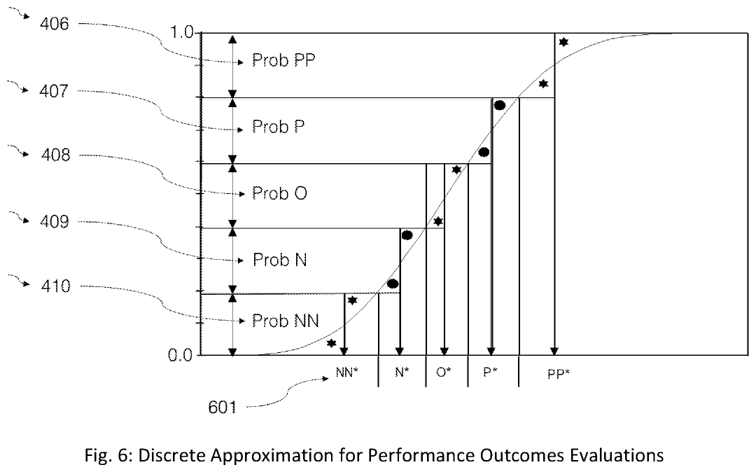

FIG. 6 shows more detail on how the subjectively-assessed probability density function may be converted into multiple probability bands, in this case, NN, N, O, P, and PP for the range very-low negative to very-high positive. This example shows 0.2 probability bands for each of the defined probability regions.

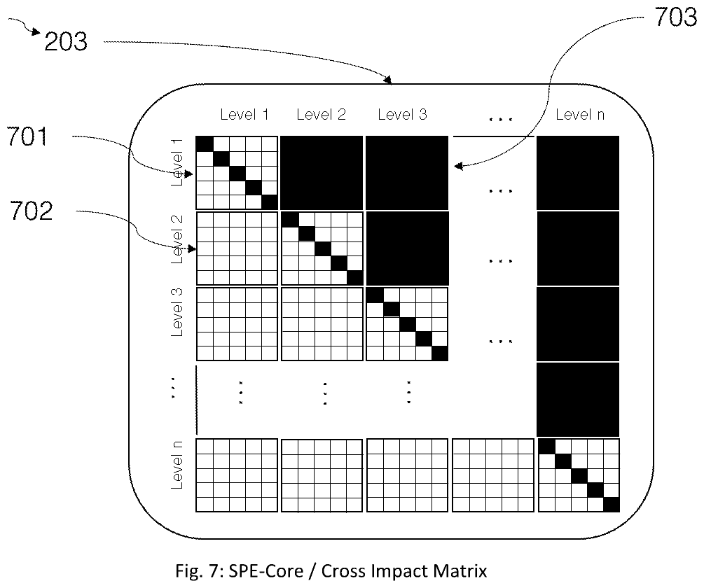

FIG. 7 depicts the propagation of conditional probability influences from lower to higher levels. The method uses a strict flow control such that variables in one Level can only impact variables in the same Level or succeeding Levels. The blacked-out portions of the matrix indicate that there are no influences among these variables. FIG. 7 represents the possible influences as a matrix, while the underlying data structure is a collection of vectors for each variable. Each vector contains the intensity and direction of impact of the variable on a succeeding variable. There are two kinds of relationships, one in the same level (sf701) and another with a higher, different level (sf702). Each cell represents a subjective impact using the set of pattern structures (sf202). There is no possibility of impacting variables in a lower-numbered Level; this shown in sf703 by the blacked-out, or no influence portion of the matrix.

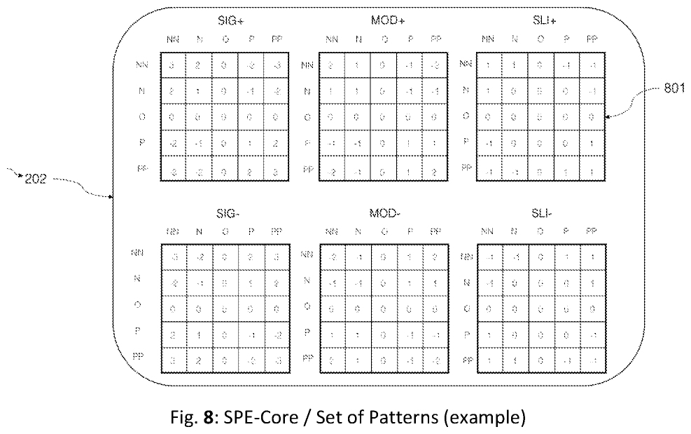

A deeper look at a portion of the vector data structures as shown in FIG. 8 demonstrates how the patterns introduced in the description of FIG. 2 earlier are used to translate impacts from one variable to a succeeding variable. Each cell in the matrix is a vector with a strength of impact and its direction. As an example, the method currently uses seven possible values defined as SIG+, MOD+, SLI+, NO (impact), SLI−, MOD−, and SIG−. These strength values may either be subjectively assessed by users or the result of using historical values collected and analyzed over time.

Each of the defined strength values (SIG+, MOD+, SLI+, NO, SLI−, MOD−, and SIG−) has its pattern representing the details of the impact. In this example, the numbers in the pattern range from highly positive to high negative and have adopted −3 to +3 as the range for defining all patterns. The definition of a pattern for SIG+ in this example has the PP-to-PP impact with a strength of 3, as well as the NN-to-NN impact. Every defined pattern has a unique identification (ID).

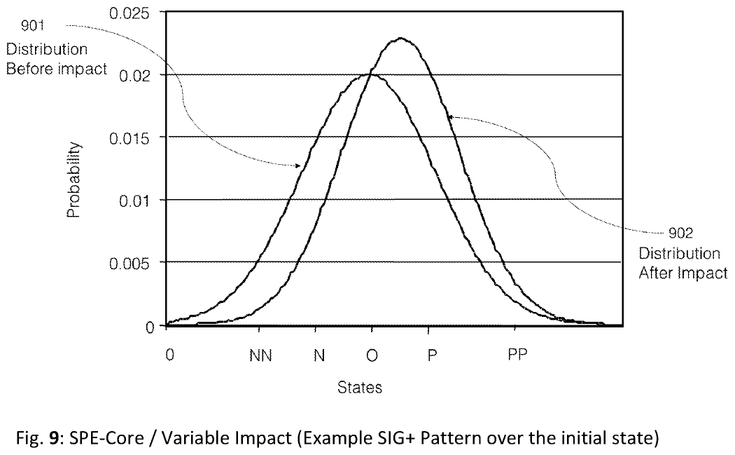

FIG. 8 represents the current set of six patterns used as defaults within the method. The pattern for NO impact has all zero entries. Patterns for the SIG (+ and −) strength values go to the highest entries, 3, while the entries for MOD (+and −) and SLI (+and −) are lower reflecting lesser impacts. Using the SIG+ value again as an example, FIG. 9 shows the net impact of the preceding variable on the succeeding variable. The combined effect of the SIG+strength shifts the probability density function for the succeeding variable toward the higher region. A MOD+ or SLI+ impact would also be toward the higher region, but with correspondingly lesser impact. The posterior shift in the probability density function is based on utilizing the Monte-Carlo simulation to repeatedly sample each distribution and propagate influences through the structured method.

### Analysis

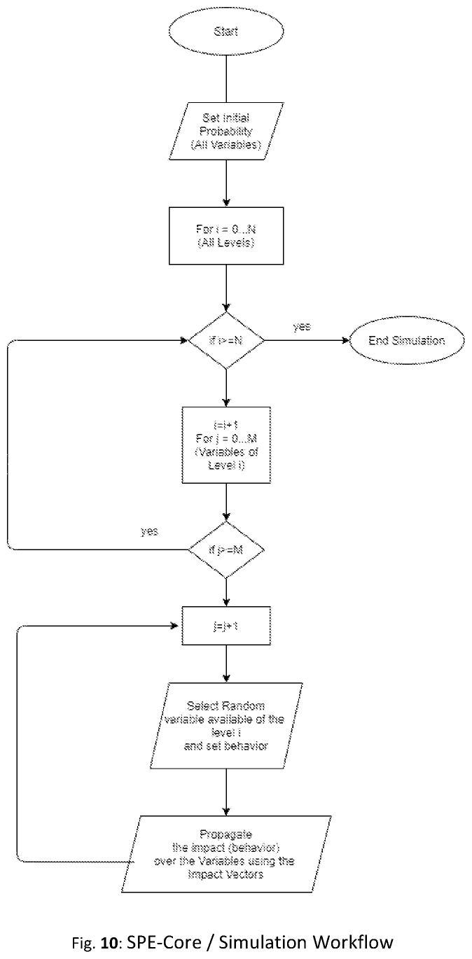

The flowchart in FIG. 10 shows the simulation process within the SPE-Core. Each pass through the flowchart represents one run of the simulation. The total number of simulation runs depends on the number of variables and complexity (basically the number of Levels and variables per level) of the model—more runs are required to reach stable outcome probability distributions when the total number of variables increases. A typical analysis may require several thousand runs to produce reasonable, stable results. Traditional tests for simulation results stability can be used to guide simulation completion. This workflow works for all possible combinations and setups for the main SPE algorithm, it represents the propagation of impacts for variables from Level 1 to Level n. Each variable affects others using the Set of Patterns and the Cross-Impact method.

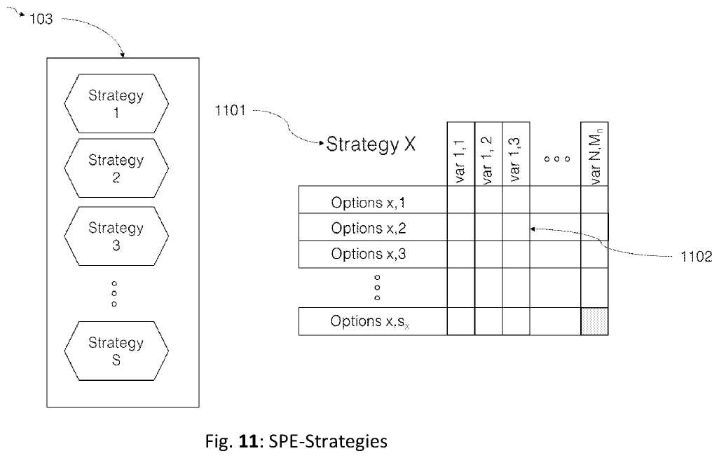

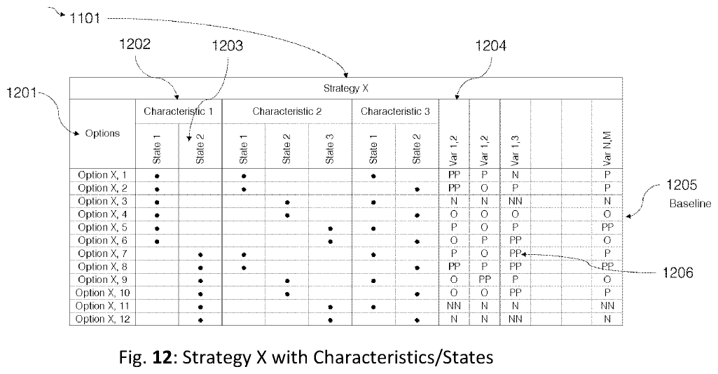

The principal focus of the method is to compare strategies based on predicted outcomes performances and risks. FIG. 11 and FIG. 12 show an approach for defining a strategy based on variables and levels. In this instance, the overall strategy is a combination of sub-strategies, each with multiple possible options. Each sub-strategy is a layer of the overall strategy. The input depicted in FIG. 12 uses the same range of impacts, NN-N-O-P-PP, to show how a particular option, say Option_{x,5} impacts a variable, say Var_{1,3}. If it has a strong negative impact, then the input would be NN. If it has no impact, then the entry is O or blank. Typically, the strategy option influences would be primarily to variables in the first Level or first 2 Levels. FIG. 12 shows a more complete example of how a strategy layer, say, Strategy X, is defined and the influences input. A baseline strategy is typically indicated as a combination of options where influences are defined as neutral, or O. This is the base or baseline strategy against which all other strategies are compared. In other words, this is the status quo or baseline strategy.

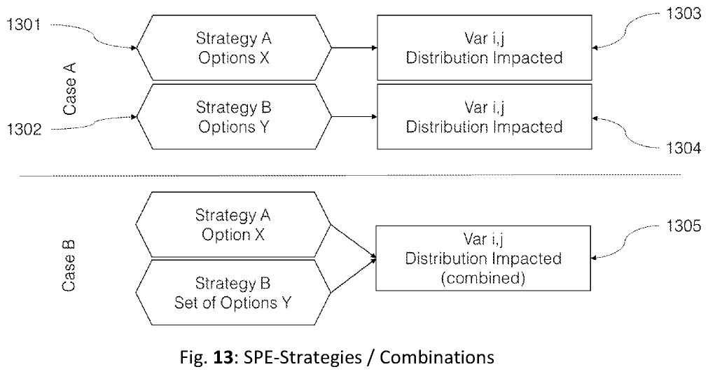

Entries in the matrix denote conditional probability relationships; namely, the outcome of the preceding variable affects the probability distribution of the succeeding variable. The same conditional relationship exists at the level where strategy option combinations influence variables at other levels. Based on this representation, joint conditional probability relationships would also apply. Thus, the combined preceding values would jointly influence the succeeding probability distribution. The method uses an approximation confirmed by analysis in developing the method and confirmed by others shown in FIG. 13. This example indicates that the nominal case (Case B) showing full, joint conditional probabilities can be approximated during the simulation as the marginal conditional probabilities shown in Case A. The error rate from the approximation has a negligible impact on the final performance outcome distributions. Using the approximation approach significantly reduces the number of subjective assessments required.

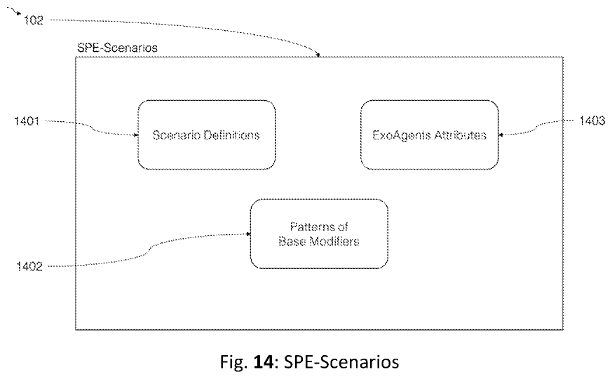

FIG. 14 introduces Scenario planning and testing as part of the analysis capability. The method allows scenarios to be defined as variations from the base case or baseline. It uses external agents or ExoAgents such as the economy or political environment to be modified and thus change the background conditions for the strategies being considered. A final component in the Scenario analysis module is the use of impact patterns to translate the changes in ExoAgents to impacts on other variables within the SPE. This approach allows the decision-maker to create alternate future environments and determine which strategies may be best for each. Similarly, a preferred or dominant strategy for the expected external conditions can be tested for robustness to changing scenarios.

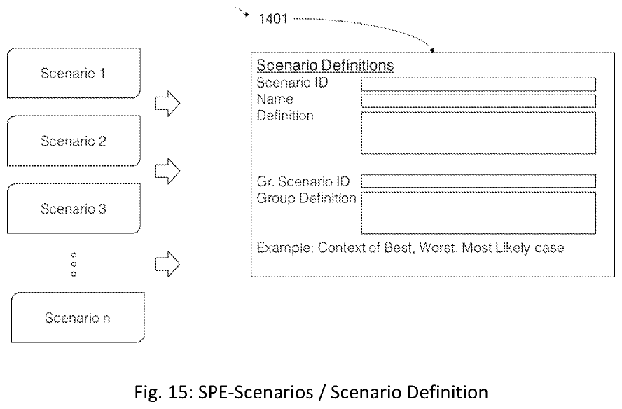

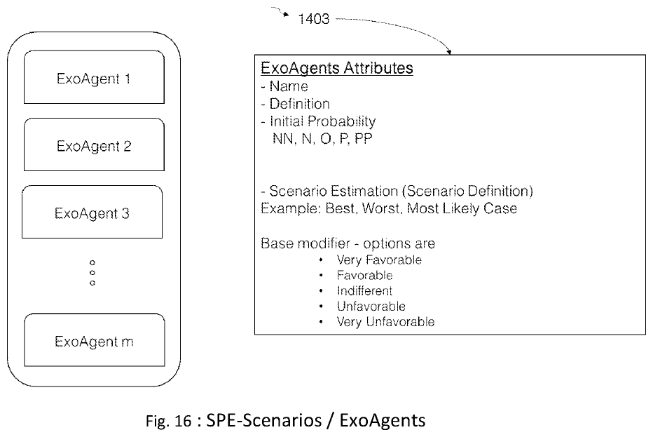

FIG. 15 and FIG. 16 provide more detail on the Scenario analysis component. As shown in FIG. 16, each scenario is named and defined. It will typically be defined in terms of extreme variations such as “worst case” or “best case” variations from the base and could vary one ExoAgent or multiple ExoAgents at a time. As an example, the base-case economy could be adjusted to its extremes of best and worst cases and the strategies tested against these new background situations.

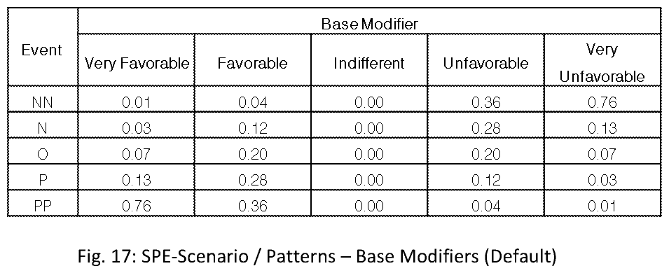

ExoAgents have the same general attributes as regular SPE core variables. FIG. 16 shows how the ExoAgents are input, and the initial probabilities are set in terms of NN, N, O, P, and PP, similar to the SPE core variables. A scenario is thus set as a combination of ExoAgents with adjusted initial probabilities. Each new scenario is described in terms of modification of the base values of the ExoAgents and defined as base modifications: very favorable, favorable, indifferent, unfavorable, and very unfavorable. FIG. 17 shows an example of how the base modifiers (very favorable through very unfavorable) change the probabilities for NN through PP. These values are the default values, but may be changed by the user to reflect stronger (or lesser) anticipated impacts.

### Uses of the Method

The selection of strategies is a complex decision involving a high degree of uncertainty. The ability to anticipate the strategies' impacts on selected performance outcomes can bring substantial benefits to the decision-making process. There is also a need to capture and codify the experiences spread throughout the organization in a way that can improve the quality of the decision-making process. To face this challenge, the SPE offers a means for structuring a systematic discussion about factors and elements in the situation at hand and providing an opportunity for organizations to analyze important aspects of their strategic decisions logically. During the structuring process, the assumptions, subjective assessments of scenarios, and internal and external conditions become explicit. The documentation of this process provides a useful historical record, which can facilitate the continuous updating of strategic scenarios, empirical information, assumptions, and perceptions of the modeling team.

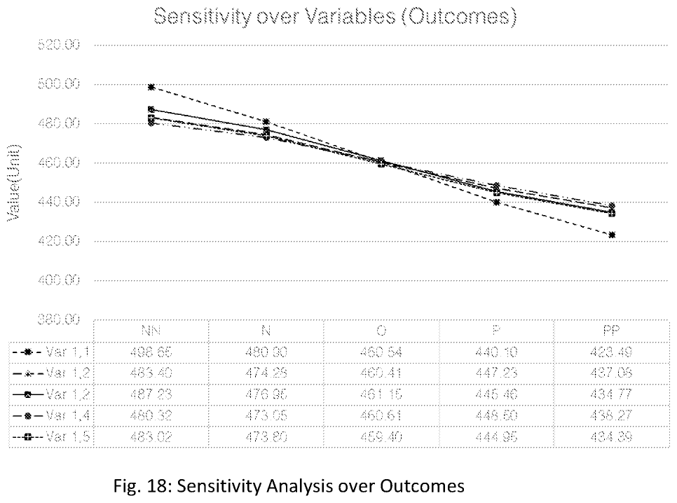

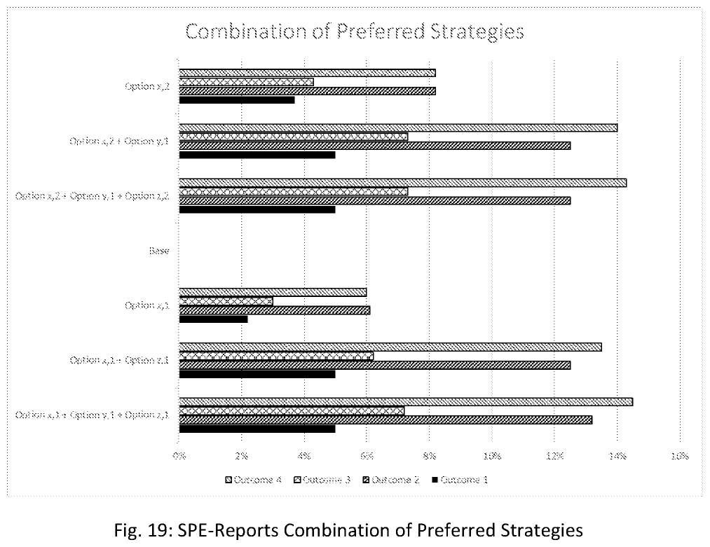

FIG. 18 and FIG. 19 show two typical and important representations of the results. FIG. 18 provides a sensitivity analysis of how any SPE core variable may impact a performance outcome over its possible range of NN-to-PP. By examining one variable at a time, the decision-maker gains a much better understanding of how strategic choices influence performance. FIG. 19 is another method output example showing how strategy choices lead to various expected performance predictions. In this example, only the most preferred strategy options and combinations are represented for the four identified performance outcomes. The method does not limit the number of performance outcomes, nor does it limit the number of combinations of strategy options to be considered.

The method can be applied to a wide range of strategy-type decisions or sensitivity tests. A primary, general use of the method is to help select long-term strategies including the impacts of changing external environments (scenarios). A specific area of possible application is project performance analysis where the method can help test and choose project execution strategies, project delivery strategies, selection of contractors or vendors, or evaluation of early-project decisions. The ability to represent changed operating environments as alternate scenarios provide a strong foundation for evaluating the impact of regulatory changes on both outcomes' performance and various stakeholders. Another possible application area is in the evaluation of proposed production process changes. As an example, lean production philosophies are gaining increasing visibility in many industries and the method provides a structured basis for evaluating process changes. In the extreme, the method can test the efficacy of disruptive production or logistics strategies. Another potential application is the rapid-action response to a rare-event occurrence. Since the method captures both multiple strategy options and ExoAgents, it allows strategy options to be quickly tested against major changes in any ExoAgent. These applications are provided as examples and do not represent all possible applications of the method.

What is claimed is:

1. A computer-implemented method for analyzing and comparing management strategies with related risk levels, the method comprises:
predicting quantitative differences in outcomes;
predicting quantitative differences in risk levels;
structuring a multi-level model of the organization and business venture factors used in comparing strategies;
inputting a user-defined number of levels in the model, a user-defined number of nodes in each model level, a user-defined set of outcome measures to be used for strategy comparisons, and a user-defined number of external factors that may impact the organizational, business venture, or outcome factors;
defining a finite number of strategy options by possible combinations of strategy components;
assessing strengths of the impact of factors at one level to factors at succeeding levels;
defining a base-case strategy using historical data and estimates from users; and
recommending preferred strategies based on combined outcome measures, risk levels, and sensitivity analyses.

2. The method of claim 1, wherein multiple strategy analysis models may be combined in series and/or parallel to create larger, more complex strategy analyses.

3. The method of claim 1, wherein subjective expert information is represented as probability distributions.

4. The method of claim 1, wherein the relationships between nodes in any two levels are represented by cross-impact matrices indicating how changes at one node impact change at a node in a succeeding level.

5. The method of claim 1, wherein the user may change, add, or delete any node at any level and the method will still function.

6. The method of claim 1, wherein subject-matter expert input on probability distributions or impact matrices may be either by individuals or groups.

7. The method of claim 1, wherein assessments for different levels of the model may be made by experts from different areas of the organization.

8. The assessments of claim 7, wherein more general (or earlier) levels of the model will be assessed less frequently and be based on the basic structure of the organization.

9. The assessments of claim 7, wherein successive levels of the model are more directly connected to the venture and will be assessed more frequently and more specifically for each strategy analysis.

10. The method of claim 1, wherein computer implementation uses a Monte-Carlo simulation engine for analyzing strategies and changes to risks and outcomes.

11. The analysis of claim 10, wherein sensitivity analyses can be performed on all nodes, outcomes, and strategy combinations.

12. The analysis of claim 10, wherein strategies with stochastic dominance over alternate strategies may be demonstrated.

13. The method of claim 1, wherein the comparison to a base case is utilized as the approach to rapidly prototype alternate strategy sets.

14. The comparison approach of claim 13, wherein the preferred strategy may be stress-tested for extreme changes in external factors.

15. The method of claim 1, wherein performance of the selected strategy may be tracked and re-evaluated over time.

16. The tracking and re-evaluation approach of claim 15, wherein new strategies may be rapidly evaluated in response to the occurrence of a rare event.

17. A scenario planning method based on the structure of claim 1, wherein different combinations of external factors may be changed and then evaluated for impact on performance outcomes.

18. The method of claim 17, wherein new and existing strategies are tested for robustness to combinations of changed, external factors.
